(19) United States
(12) Patent Application Publication
(10) Pub. No.: US 2017/0043508 A1
(43) Pub. Date: Feb. 16, 2017

(54) Method and Device for Monitoring a Vulcanization Process

(71) Applicant: Siemens Aktiengesellschaft, Muenchen (DE)

(72) Inventors: Matthias Goldammer, Muenchen (DE); Hubert Mooshofer, Muenchen (DE); Stefan Morgenstern, Nuernberg (DE); Detlef Rieger, Baldham (DE)

(73) Assignee: Siemens Aktiengesellschaft, Muenchen (DE)

(21) Appl. No.: 15/306,395

(22) PCT Filed: Mar. 25, 2015
(86) PCT No.: PCT/EP2015/056347

§ 371 Date: Oct. 24, 2016

(30) Foreign Application Priority Data
Apr. 24, 2014 (DE) 10 2014 207 700.1

(51) Int. Cl. B29C 35/02

(52) U.S. Cl. CPC B29C 35/0288

(57) ABSTRACT

A method for monitoring a vulcanization process of a vulcanization mixture contained in a tool may include using an emitter to emit ultrasonic waves toward a boundary surface between the vulcanization mixture and the tool, wherein boundary surface reflects at least part of the ultrasonic waves. The vulcanization process may be monitored as a function of at least part of the emitted ultrasonic waves reflected by the boundary surface, wherein the ultrasonic waves include at least transverse waves generated by the emitter.

### CROSS-REFERENCE TO RELATED APPLICATIONS

This application is a U.S. National Stage Application of International Application No. PCT/EP2015/056347 filed Mar. 25, 2015, which designates the United States of America, and claims priority to DE Application No. 10 2014 207 700.1 filed Apr. 24, 2014, the contents of which are hereby incorporated by reference in their entirety.

### TECHNICAL FIELD

The invention relates to methods and devices for monitoring a vulcanization process.

### BACKGROUND

Methods and devices of this type for monitoring a vulcanization process of a vulcanization mixture accommodated in a tool are known from DE 101 38 791 A1. In the method, ultrasonic waves are emitted by means of an emitting device in the direction of a boundary surface between the vulcanization mixture and the tool. The tool is, for example, a mold, in particular a heating press, which has a receptacle in the form of a cavity. The vulcanization mixture is arranged in the receptacle.

The vulcanization mixture is molded by means of the tool. As a result, a product to be made by the vulcanization process from the vulcanization mixture has this form pre-determined or pre-determinable by the cavity or the tool following the vulcanization process.

In the context of the method, the vulcanization process is monitored depending on at least a part of the emitted ultrasonic waves which are reflected at the boundary surface. This means that a detection device is provided by means of which at least a part of the ultrasonic waves emitted and reflected at the boundary surface is detected. The device can herein have an evaluation device for monitoring the vulcanization process depending on the detected ultrasonic waves.

The aforementioned product to be produced by the vulcanization process from the vulcanization mixture is, for example, a tire. It is known from the general prior art to vulcanize tires or to produce tires by vulcanization in large numbers in hot presses. A hot press of this type is a tool which has, for example, the aforementioned receptacle. In order to produce a tire, the vulcanization mixture is introduced, for example, together with a casing fabric of the tire, into the hot press. A final shape of the tire and a tire profile are produced by means of the hot press under pressure and temperature. In the context of the vulcanization process, the initially still fluid vulcanization mixture which comprises for example at least rubber and sulfur additives becomes cross-linked to elastic tire rubber. This vulcanization process can last, depending on the tire type and the tire size, between a few minutes and a few hours. The tire rubber has a solid physical state.

In the context of the development of tire types, precise standards are defined for the production by means of the hot press. Particularly important parameters for the vulcanization process are the pressure, the temperature and their distribution in the hot press, and also the duration of the vulcanization process.

Conventionally—in order to ensure a reliable vulcanization of the tire—the temperature distribution at a plurality of measuring points and the pressure are continuously recorded during the vulcanization process, that is, detected and as far as possible set, that is, regulated. Since with all the parameters, for example, the composition of the vulcanization mixture representing a starting material, the environmental conditions and the state of the hot press, process variations can occur, an additional process time can be factored in, in order to ensure reliable cross-linking of the vulcanization mixture at all sites of the tire. The magnitude of this additional process time is set as a safety buffer for the process development for each tire type individually.

The setting of such an additional process time results in a time-intensive and therefore cost-intensive production process for tires. In order to keep the time and costs for producing the tires low, a so-called online process control of the vulcanization process is desirable. In the context of such an online process control, the conversion of the initially still liquid vulcanization mixture to elastic rubber during the manufacturing of the product should be detected.

By this means, the factoring in of an additional process time in order to even out any variations in the process parameters can be avoided or at least lessened. In other words, by means of direct online monitoring or online measurement of the vulcanization process in the receptacle, in particular in the hot press, in particular at critical sites of the product, the production time can be markedly reduced overall. Specifically, an online process control of this type would enable a move away from a fixed formula-oriented production process to a state-oriented optimized production. A reduction of the process time and of energy costs in a mass production such as tire manufacturing would enable a marked increase in productivity. Such a direct online measurement of the vulcanization process would also be advantageous in the development of new products such as new tires and the associated production formulae.

U.S. Pat. No. 6,885,791 B2 discloses a method and a device for monitoring a vulcanization process of a vulcanization mixture, wherein the vulcanization process is monitored by dielectric means or impedance means.

### SUMMARY

One embodiment provides a method for monitoring a vulcanization process of a vulcanization mixture accommodated in a tool, wherein by means of an emitting device, ultrasonic waves are emitted in the direction of a boundary surface between the vulcanization mixture and the tool, said boundary surface reflecting at least a part of the ultrasonic waves, wherein the vulcanization process is monitored depending on at least a part of the emitted ultrasonic waves which are reflected at the boundary surface, wherein the ultrasonic waves comprise at least transverse waves which are generated by means of the emitting device.

In one embodiment, the transverse waves are generated by means of the emitting device temporally before the reflection of the ultrasonic waves caused by the boundary surface.

In one embodiment, the emitting device comprises at least one ultrasonic emitter by means of which the transverse waves are generated.

In one embodiment, the emitting device comprises at least one ultrasonic emitter by means of which longitudinal waves are generated as the ultrasonic waves and are emitted in the direction of at least one reflection element of the emitting device, by means of which reflection element at least a part of the longitudinal waves is transformed into the transverse waves.

In one embodiment, at least one further reflection element is provided, by means of which at least a part of the ultrasonic waves reflected by means of the boundary surface in the direction of the further reflection element is reflected back to the boundary surface.

In one embodiment, at least one receiving element is provided by means of which at least a part of the ultrasonic waves reflected initially at the boundary surface, then by means of the further reflection element and then again at the boundary surface is received.

In one embodiment, the at least one ultrasonic emitter is configured as an ultrasonic transducer by means of which the reflected ultrasonic waves are detected.

In one embodiment, the emitting device comprises at least one receiving element by means of which longitudinal waves are detected as the ultrasonic waves reflected at the boundary surface, wherein the vulcanization process is monitored depending on the detected longitudinal waves.

In one embodiment, the method includes detection of a first part of the ultrasonic waves reflected at the boundary surface and detection of a second part of the ultrasonic waves different from the first part and reflected by means of a reference reflection element; determination of a measurement signal depending on the first part; determination of a normalizing signal depending on the second part; normalization of the measurement signal by means of the normalizing signal; and monitoring of the vulcanization process based upon the normalized measurement signal.

Another embodiment provides a device for monitoring a vulcanization process of a vulcanization mixture accommodated in a tool, having an emitting device for emitting ultrasonic waves in the direction of a boundary surface between the vulcanization mixture and the tool, said boundary surface reflecting at least a part of the ultrasonic waves, said device having a detection device for detecting at least a part of the emitted ultrasonic waves which are reflected at the boundary surface, and having an evaluation device for monitoring the vulcanization process depending on the ultrasonic waves detected, wherein the emitting device is configured to generate at least transverse waves as the ultrasonic waves.

Another embodiment provides a method for monitoring a vulcanization process of a vulcanization mixture accommodated in a tool, wherein by means of an emitting device, ultrasonic waves are emitted in the direction of a boundary surface, between the vulcanization mixture and the tool, said boundary surface at least partially reflecting the ultrasonic waves, the method including: detection of a first part of the ultrasonic waves reflected at the boundary surface and detection by means of a detection device of a second part of the ultrasonic waves different from the first part and reflected by means of at least one reference reflection element; determination of a measurement signal depending on the first part; determination of a normalizing signal depending on the second part; normalization of the measurement signal by means of the normalizing signal; and monitoring of the vulcanization process based upon the normalized measurement signal.

Another embodiment provides a device for monitoring a vulcanization process of a vulcanization mixture accommodated in a tool, having an emitting device for emitting ultrasonic waves in the direction of a boundary surface between the vulcanization mixture and the tool, said boundary surface reflecting at least a part of the ultrasonic waves, the device comprising: a detection device for detecting a first part of the ultrasonic waves reflected at the boundary surface and for detecting a second part of the ultrasonic waves different from the first part and reflected by means of at least one reference reflection element; and an evaluation device configured to determine a measurement signal depending on the first part, to determine a normalizing signal depending on the second part, to normalize the measurement signal by means of the normalizing signal and to monitor the vulcanization process based upon the normalized measurement signal.

### BRIEF DESCRIPTION OF THE DRAWINGS

Example aspects and embodiments of the invention are described below with reference to the drawings, in which:

FIG. 1 is a partial representation of a schematic sectional view of a tool in the form of a hot press according to a first embodiment, wherein by means of the hot press, an initially fluid vulcanization mixture is cross-linked in the context of a vulcanization process and wherein the vulcanization process is monitored by means of transverse waves;

FIG. 2 is a graphical representation which shows a measurement signal and a normalizing signal in the form of a reference signal for normalizing the measurement signal, wherein the vulcanization process is monitored by means of the normalized measurement signal;

FIG. 3 is a graphical representation to illustrate the change of the normalized measurement signal on increasing cross-linking of the vulcanization mixture; and

FIG. 4 is a partial representation of a schematic sectional view of the hot press according to a second embodiment.

### DETAILED DESCRIPTION

Embodiments of the present invention provide a method and a device of the type mentioned in the introduction such that a particularly time-saving and cost-saving production of products by vulcanization can be realized.

Some embodiments provide a method for monitoring a vulcanization process of a vulcanization mixture accommodated in a tool. In the method, by means of an emitting device, ultrasonic waves are emitted in the direction of a boundary surface between the vulcanization mixture and the tool, said boundary surface reflecting at least a part of the ultrasonic waves. Furthermore, the vulcanization process is monitored depending on at least a part of the emitted ultrasonic waves which are reflected at the boundary surface.

In order to be able now to realize a particularly time and cost-efficient production of at least one product from the vulcanization mixture by its vulcanization process, it is provided according to the invention that the ultrasonic waves comprise at least transverse waves which are generated by means of the emitting device. In other words, by means of the emitting device, transverse waves are generated as the ultrasonic waves. It can herein be provided that the transverse waves are generated such that the ultrasonic waves are emitted by means of the emitting device, in particular in the form of longitudinal waves, in the direction of the boundary surface and in particular inclined to the boundary surface such that by reflection of the emitted ultrasonic waves at the boundary surface, transverse waves are produced. It can further be provided that the transverse waves are generated by means of the emitting device temporally before the reflection of ultrasonic waves caused by the boundary surface. In other words, the transverse waves are generated by means of the emitting device before the ultrasonic waves reach the boundary surface, in particular for the first time, and are reflected there. This means that in this embodiment, the transverse waves do not arise firstly by means of the reflection of the ultrasonic waves at the boundary surface, but beforehand by means of the emitting device and are emitted in the direction of the boundary surface so that already generated and emitted transverse waves can be reflected, if required, at the boundary surface.

One concept underlying embodiments of the invention is to realize a previously described direct online measurement or online monitoring of the vulcanization process by ultrasonic measurement. A central idea of the invention is that of making optimum use of the phenomenon that transverse waves can propagate in solid media, though not in fluid media. In other words, the invention is based on the realization that a marked and clear difference exists between the propagation of transverse waves in fluid media and the propagation of transverse waves in solid media.

A fluid medium of this type is, for example, the initially still fluid vulcanization mixture which—when it is not yet cross-linked—has a fluid physical condition. Such a solid medium may be the product which constitutes rubber. The as yet still fluid vulcanization mixture converts as a result of the vulcanization into the elastic rubber. The rubber has a solid physical condition. In other words, the rubber is solid. This should be understood as meaning that the rubber is elastic, but—in contrast to the liquid physical condition of the not yet vulcanized vulcanization mixture—has a solid physical condition, meaning that it is no longer fluid, but retains its form independently.

Since in fluids, for example, the initially still fluid vulcanization mixture, no shearing or shear stresses are transmitted, no transverse waves can propagate in liquids such as, for example, the initially fluid vulcanization mixture. Transverse waves do however propagate in solid media. A solid medium of this type is, for example, the product which is produced from the vulcanization mixture by means of the vulcanization process.

The initially still fluid vulcanization mixture becomes cross-linked to elastic rubber by means of the vulcanization process. This elastic rubber is a solid medium in which transverse waves can propagate.

Furthermore, underlying the invention is the recognition that transverse waves propagate in solid media at a lower propagation velocity than ultrasonic waves in the form of longitudinal waves. This difference in the propagation capability of longitudinal waves and transverse waves is utilized for the monitoring of the vulcanization process. In particular, this difference is used to detect a transition of an initially still fluid phase in the form of the still fluid vulcanization mixture to a cross-linked phase in the form of the elastic rubber.

The disclosed method can be used, for example, in a hot press as the tool, by means of which the initially still fluid vulcanization mixture is vulcanized under pressure and temperature and is thus converted to solid, elastic rubber. By means of the method according to the invention, the vulcanization process can be monitored particularly precisely so that it can be detected particularly exactly at which time point the vulcanization process is completed. By this means, the time and, as a result, the costs for manufacturing a product, for example a tire, from the vulcanization mixture can be kept particularly low. Thus, the method according to the invention enables the provision of a particularly time and cost-efficient mass production of products by vulcanization.

In order to generate the ultrasonic waves, for example, at least one ultrasonic emitter is provided. The ultrasonic emitter may be configured as an ultrasonic transducer by means of which the ultrasonic waves are generated and emitted and also the reflected ultrasonic waves are detected.

In one embodiment, the at least one ultrasonic emitter is configured to generate transverse waves. This means that transverse waves are directly generated by means of the ultrasonic emitter. In other words, the ultrasonic waves which are generated by means of the ultrasonic emitter and emerge therefrom already comprise transverse waves. By this means, a particularly high proportion of a transverse component in the ultrasonic waves can be realized, wherein this transverse component is transmitted into the rubber.

The generation of a particularly high proportion of the transverse components in the ultrasonic waves is based on the concept that, depending on the reflected and detected ultrasonic waves, at least one measurement signal is determined. Depending on this measurement signal, the vulcanization process is monitored. Based on the stated transition from the initially still fluid vulcanization mixture to the solid elastic rubber and due to the different propagation velocities of longitudinal waves and transverse waves in solid media, a change in the measurement signal accompanies the increasing vulcanization of the vulcanization mixture.

Through the realization of a particularly high proportion of the transverse components in the ultrasonic waves, this signal change can be optimized so that, as a result of the vulcanization of the vulcanization mixture, a clear difference or a clear change in the measurement signal comes about. This clear signal change can be detected in a simple time and cost-efficient manner so that the vulcanization process can be monitored particularly time and cost-efficiently.

In order to realize the high proportion of transverse components of the ultrasonic waves, the ultrasonic emitter is configured, for example, as an ultrasonic test probe which can generate transverse waves.

It may be advantageous if the emitting device comprises at least one ultrasonic emitter by means of which longitudinal waves are generated as the ultrasonic waves and are emitted in the direction of at least one reflection element of the emitting device different from the boundary surface. By means of the reflection element, at least a part of the longitudinal waves are transformed into the transverse waves. For example, the longitudinal waves are deflected by means of the reflection element with transformation of at least a part of the longitudinal waves into transverse waves, and emitted in the direction of the boundary surface.

This embodiment is based on the recognition that ultrasonic emitters in the form of ultrasonic test probes which are configured to generate and emit longitudinal waves, are available in large numbers and cost-efficiently. Through the use of the cost-efficient reflection element, despite the use of such an ultrasonic test probe configured to generate longitudinal waves, transverse waves can be generated, by means of which the vulcanization can be monitored particularly precisely and cost-efficiently. Thus the use of an ultrasonic test probe configured to generate transverse waves can be avoided.

In one embodiment, at least one further reflection element which differs from the boundary surface and the reflection element is provided, by means of which at least a part of the ultrasonic waves reflected by means of the boundary surface in the direction of the further reflection element is reflected back to the boundary surface. By this means, a double reflection of the ultrasonic waves at the boundary surface can be realized.

At least a part of the ultrasonic waves initially emitted by the emitting device in the direction of the boundary surface is initially reflected at the boundary surface for the first time and thereby, for example, deflected so that the at least one part is deflected or emitted from the boundary surface in the direction of the further reflection element. At least a part of the ultrasonic waves reflected at the boundary surface is reflected by means of the further reflection element in the direction of the boundary surface so that at least a part of the ultrasonic waves is reflected a second time at the boundary surface following the reflection at the further reflection element.

At least a part of the ultrasonic waves reflected at the boundary surface for the second time can be detected wherein the aforementioned measurement signal can be determined depending on these ultrasonic waves reflected twice at the boundary surface. Depending on the measurement signal, the vulcanization process is then monitored. By means of this double reflection and by means of the detection of the ultrasonic waves reflected twice at the boundary surface, the transition of the fluid vulcanization mixture to the elastic rubber can be detected particularly well. Furthermore, by this means, the method can be carried out in a hot press particularly simply and cost-efficiently. The double reflection of the ultrasonic waves at the boundary surface between the vulcanization mixture and the tool may be carried out at an oblique angle, wherein a total reflection of the ultrasonic waves at the boundary surface may be omitted.

In a further embodiment, at least one receiving element is provided by means of which at least a part of the ultrasonic waves reflected initially at the boundary surface, then by means of the further reflection element and then again at the boundary surface is received. In other words at least a part of the ultrasonic waves reflected twice at the boundary surface is detected by means of the receiving element. Depending on these ultrasonic waves reflected twice at the boundary surface, a measurement signal can be generated, based upon which the vulcanization process can be monitored particularly precisely.

It may be advantageous if the at least one ultrasonic emitter is configured as an ultrasonic transducer by means of which the reflected ultrasonic waves are detected. By this means, the number of parts and the space requirement of a device for carrying out the method according to the invention can be kept particularly low.

In a further embodiment, the emitter comprises at least one receiving element by means of which longitudinal waves are detected as the ultrasonic waves reflected, in particular, twice at the boundary surface, wherein the vulcanization process is monitored depending on the detected longitudinal waves. This means, for example, that an intensity of the longitudinal waves reflected at the boundary surface is measured as the measurement signal.

This embodiment is based on the concept that the intensity of the reflected longitudinal waves depends distinctly on the state of the vulcanization mixture. In particular, the intensity of the reflected longitudinal waves depends on how strongly the transverse waves can propagate in the vulcanization mixture. The propagation of transverse waves in the vulcanization mixture is itself dependent on the progress of the vulcanization process and thus on the state of cross-linking of the vulcanization mixture during vulcanization. The degree of cross-linking and thus the progress of the vulcanization process can therefore be measured particularly precisely by means of a change in the intensity of the twice reflected longitudinal waves. The aforementioned at least one receiving element for detecting the longitudinal waves can be the aforementioned receiving element.

In a further embodiment, a first part of the ultrasonic waves reflected at the boundary surface and a second part of the ultrasonic waves different from the first part and reflected by means of at least one reference reflection element different from the boundary surface and the aforementioned reflection elements are detected. The two parts are detected, for example, by means of the aforementioned receiving element. The second part is independent of any change on or in the boundary surface, that is the second part is independent of any change in the vulcanization mixture, since the second part is reflected before the boundary surface, that is not by it.

The measurement signal is determined depending on the detected first part. Depending on the second part, a normalizing signal is determined. Finally, the measurement signal is normalized by means of the normalizing signal. The vulcanization process is finally monitored by means of the normalized measurement signal.

The second part concerns an ultrasonic echo of the reference reflection element. This ultrasonic echo is used as a normalizing signal or to determine a normalizing signal for the measurement signal in order thereby, for example, to ensure a reliable detection of the intensity of the longitudinal waves. As a result, it is possible to detect precisely a change in the intensity occurring with increasing cross-linking of the vulcanization mixture.

By means of the normalization of the measurement signal, changes in the emitting device, in particular the ultrasonic emitter, can be compensated for. For example, with increasing service life, a change in the emitted ultrasonic energy of the ultrasonic emitter can occur. This change in the emitted ultrasonic energy is brought about by means, for example, of the aging of the ultrasonic emitter and/or by changing the coupling of the ultrasonic emitter to the tool. These changes can be compensated for by normalizing the measurement signal. In this way, through a long service life of the tool and the emitting device, a precise monitoring of the vulcanization process can be realized.

Other embodiments provide a device for monitoring a vulcanization process of a vulcanization mixture accommodated in a tool, having an emitting device for emitting ultrasonic waves in the direction of a boundary surface between the vulcanization mixture and the tool, said boundary surface reflecting at least a part of the ultrasonic waves, and said device having a detection device for detecting at least a part of the emitted ultrasonic waves which are reflected at the boundary surface, and having an evaluation device for monitoring the vulcanization process depending on the ultrasonic waves detected by the detection device.

In order to be able now to realize a particularly time and cost-efficient production of a product from the vulcanization mixture by the vulcanization process, it is provided according to the invention that the emitting device is configured to generate at least transverse waves as the ultrasonic waves. The emitting device can be configured, in particular, to emit as the ultrasonic waves, transverse waves temporally before the reflection of the ultrasonic waves brought about, in particular for the first time, by the boundary surface. In other words, the device is configured to carry out a method according to the first aspect of the invention. Advantageous embodiments of the first aspect of the invention are to be considered advantageous embodiments of the second aspect of the invention and vice versa.

Other embodiments provide a method for monitoring a vulcanization process of a vulcanization mixture accommodated in a tool. In the method of the third aspect, by means of an emitting device, ultrasonic waves are emitted in the direction of a boundary surface between the vulcanization mixture and the tool, said boundary surface at least partially reflecting the ultrasonic waves.

In order to realize a particularly simple, time and cost-efficient production of a product from the vulcanization mixture, it is provided according to the invention that a first part of the ultrasonic waves reflected at the boundary surface and a second part of the ultrasonic waves different from the first part and reflected by means of at least one reference reflection element different from the boundary surface are detected by means of a detection device.

Furthermore, a measurement signal is determined depending on the first part. Furthermore, a normalizing signal is determined depending on the second part. The measurement signal is normalized by means of the normalizing signal and the vulcanization process is monitored by means of the normalized measurement signal. Advantageous embodiments of the first two aspects of the invention are to be considered advantageous embodiments of the third aspect of the invention and vice versa.

Some embodiments are based on the recognition that with increasing service lifetime with increasing lifespan, a change in the emitting device and/or the tool can occur. As described above, the emitting device, in particular an ultrasonic emitter of the emitting device can age, which is associated with a change in the emitted ultrasonic energy. Furthermore, a change can take place in the coupling of the emitting device to the tool. By means of the normalizing of the measurement signal, these changes can be compensated for so that the vulcanization process can also be monitored particularly precisely over a long service life. By this means, any buffer times that are to be provided in the manufacturing of a product from the vulcanization mixture can be kept particularly short.

Other embodiments provide a device for monitoring a vulcanization process of a vulcanization mixture accommodated in a tool, with an emitting device for emitting ultrasonic waves in the direction of a boundary surface between the vulcanization mixture and the tool, said boundary surface reflecting at least a part of the ultrasonic waves.

In order to realize a particularly time and cost-efficient production of a product from the vulcanization mixture by vulcanization, the device of the fourth aspect of the invention is configured to carry out a method according to the third aspect of the invention. This means that the device of the fourth aspect of the invention comprises a detection device for detecting a first part of the ultrasonic waves reflected at the boundary surface and for detecting a second part of the ultrasonic waves different from the first part and reflected by means of at least one reference reflection element different from the boundary surface. The device further comprises an evaluation device which is configured to determine a measurement signal depending on the first part, to determine a normalizing signal depending on the second part, to normalize the measurement signal by means of the normalizing signal and to monitor the vulcanization process based upon the normalized measurement signal. Advantageous embodiments of the first three aspects of the invention are to be considered as advantageous embodiments of the fourth aspect of the invention and vice versa.

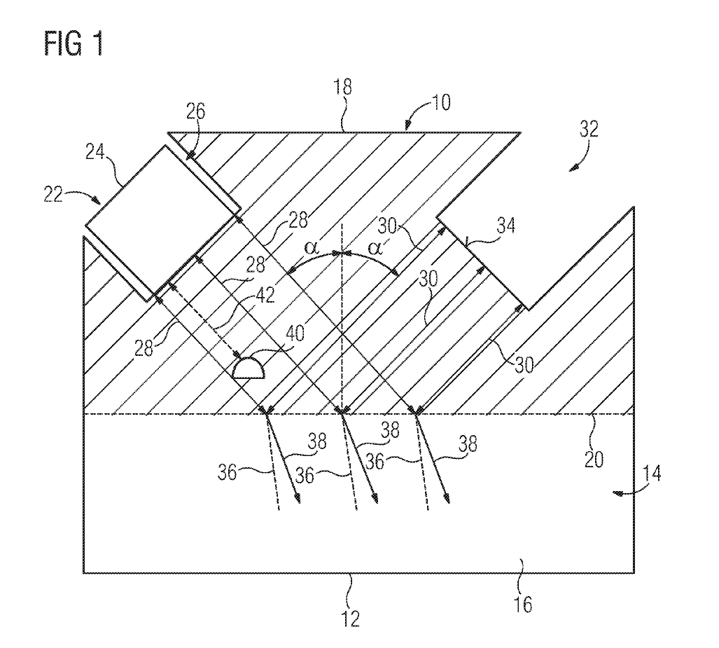

FIG. 1 shows in a schematic sectional view a tool in the form of a hot press identified overall as 10, according to a first embodiment. The hot press 10 is a tool which has a lower, first tool part 12 with a cavity 14. The cavity 14 is a receptacle of the hot press 10, wherein a vulcanization mixture 16 is accommodated in the receptacle (cavity 14).

Furthermore, the hot press 10 comprises an upper, second tool part 18. The second tool part 18 is formed, for example, from a metallic material, in particular a steel. A mold is formed by the tool parts 12, 18 by means of which the vulcanization mixture 16 is molded.

By means of the hot press 10, the vulcanization mixture 16 accommodated in the receptacle and initially still fluid is vulcanized. This means that by means of the hot press 10, under pressure and temperature, a vulcanization process of the initially still fluid vulcanization mixture 16 is brought about. In the course of the vulcanization process, the vulcanization mixture 16 cross-links so that the initially still fluid vulcanization mixture 16 is converted into elastic and thus solid rubber. Thus a product such as, for example, a tire for a wheel of a vehicle is produced from the vulcanization mixture 16, wherein the finished product is formed from the elastic rubber. The finally manufactured product made of the elastic rubber has a form pre-determined or pre-determinable by the tool parts 12, 18.

It is apparent from FIG. 1 that the vulcanization mixture 16 is accommodated in the tool (hot press 10). Also recognizable in FIG. 1 is a boundary surface 20 between the vulcanization mixture 16 and the tool part 18. Thus the boundary surface 20 is a boundary surface between the vulcanization mixture 16 and the tool (hot press 10).

In order to realize a particularly time and cost-efficient production of the product, a so-called online measurement is provided by means of which the vulcanization process, that is, the cross-linking of the initially still fluid vulcanization mixture 16 is monitored. In order to realize this online measurement, an emitting device identified overall as 22 is provided. The emitting device 22 comprises at least one ultrasonic transducer 24. The ultrasonic transducer 24 is configured as an ultrasonic emitter by means of which ultrasonic waves can be generated and emitted. Furthermore, the ultrasonic transducer 24 is configured as a receiving element by means of which ultrasonic waves, in particular reflected ultrasonic waves, can be received and therefore detected. Thus the emitting device 22 is also configured as a detection device for detecting, in particular, reflected ultrasonic waves. The ultrasonic transducer 24 is, for example, firmly connected to the tool part 18.

FIG. 1 shows the hot press 10 according to a first embodiment. It can be seen from FIG. 1 that the tool part 18 comprises a receptacle 26 in which the ultrasonic transducer 24 is at least partially accommodated. The receptacle 26 is configured as a blind bore so that the receptacle 26 is limited toward the vulcanization mixture 16. Thus the ultrasonic transducer 24 is separated by the metallic material of the tool part 18 from the vulcanization mixture 16. For example, the receptacle 26 is configured as a bore of the tool part 18.

In the context of the monitoring of the vulcanization process, ultrasonic waves are emitted by means of the ultrasonic transducer in the direction of the boundary surface 20 between the vulcanization mixture 16 and the tool part 18, said boundary surface reflecting at least a part of the ultrasonic waves. The ultrasonic waves emitted by the ultrasonic transducer 24 are illustrated in FIG. 1 by solid double-headed arrows 28. The ultrasonic transducer 24 is herein arranged relative to the boundary surface 20 and relative to the tool part 18 such that the ultrasonic waves emitted by the ultrasonic transducer 24 are incident on the boundary surface 20 at an oblique angle α.

These ultrasonic waves reflected at the boundary surface 20 are illustrated in FIG. 1 by solid double-headed arrows 30. The emitting device 22 comprises a reflection element 32 which is identified as “reflector” and has a reflection surface 34. The reflection element 32 is configured as a recess, in particular as a bore of the tool part 18, wherein the reflection surface 34 is formed by a substantially flat and even floor of the recess. In other words, the reflection element 32 is configured, for example, as a flat-bottomed bore of the tool part 18 and therefore of the hot press 10.

At least a part of the ultrasonic waves reflected at the boundary surface 20 is reflected at the boundary surface 20 such that this part is incident upon the reflection element 32. At least a part of the ultrasonic waves reflected at the boundary surface 20 in the direction of the reflection element 32 is reflected back by means of the reflection element 32 in the direction of the boundary surface 20. The ultrasonic waves reflected by the reflection element 32 or at least a part of these reflected ultrasonic waves are incident on and/or are or is again reflected at the boundary surface 20, this time in the direction of the ultrasonic transducer 24.

The ultrasonic waves reflected for the second time at the boundary surface 20 are incident on the ultrasonic transducer 24 and are sensed by means of the ultrasonic transducer 24, that is, detected. The vulcanization process is monitored depending on the ultrasonic waves reflected twice at the boundary surface 20 and detected by means of the ultrasonic transducer 24.

Depending on these ultrasonic waves reflected twice at the boundary surface 20 and detected by means of the ultrasonic transducer 24, at least one measurement signal is determined. The measurement signal is determined, for example, by means of an evaluation device not shown in FIG. 1, which is electrically coupled to the ultrasonic transducer 24. The monitoring of the vulcanization process herein takes place depending on the measurement signal.

The ultrasonic transducer 24 is configured, for example, for generating and emitting longitudinal waves as the ultrasonic waves. This means that by means of the ultrasonic transducer 24, ultrasonic waves are generated and emitted in the form of longitudinal waves. The longitudinal waves generated and emitted by means of the ultrasonic transducer 24 are not only reflected for the first time at the boundary surface 20, but also penetrate into the vulcanization mixture 16 and there are transmitted and at least partially absorbed. Herein, the longitudinal waves split into transverse waves and longitudinal waves. The transverse waves arising at the boundary surface 20 are illustrated in FIG. 1 by dashed arrows 36. The longitudinal waves penetrating into the vulcanization mixture 16 are illustrated in FIG. 1 by means of solid arrows 38.

Longitudinal waves and transverse waves have different propagation capabilities in fluids and solid media. In fluid media, that is in liquids and thus in the initially still fluid vulcanization mixture 16, no shear stresses can be transmitted, so that no transverse waves can propagate in fluid media. However, longitudinal waves can propagate in fluid media.

In solid media, both transverse and longitudinal waves can propagate, but at different propagation velocities. Herein, transverse waves have a lower propagation velocity than longitudinal waves. Due to the different propagation velocities, the longitudinal waves and the transverse waves are refracted differently at the boundary surface 20. This takes place equally on the first reflection of the ultrasonic waves at the boundary surface 20 and on the second reflection of the ultrasonic waves at the boundary surface 20. For reasons of clarity, in FIG. 1 only the ultrasonic waves of the first reflection at the boundary surface 20 are shown.

In the mold (hot press 10) also, following the reflection, both longitudinal waves and also transverse waves arise (not shown here). However, herein only the longitudinal waves are reflected at an angle α, wherein the angle α is identified as the “reflection angle”. In other words, only the longitudinal waves are reflected at the reflection angle and, in the symmetrical arrangement shown in FIG. 1 can reach and enter into the ultrasonic transducer 24. These longitudinal waves reflected twice at the boundary surface 20 are detected by means of the ultrasonic transducer 24.

If, for example, the boundary surface 20 is delimited between a solid first medium in the form of the tool part 18 and a second solid medium in the form of the rubber, then an ultrasonic wave incident obliquely on the boundary surface 20 is split into four individual components, specifically both on the first and second reflection, into respectively a longitudinal wave and a transverse wave, or a longitudinal and a transverse component. This applies for a configuration without total reflection. If, however, the vulcanization mixture 16 is still fluid, then the boundary surface 20 is delimited between a solid first medium in the form of the tool part 18 and a fluid second medium in the form of the initially still fluid vulcanization mixture 16. For this case of the boundary surface 20, however, a splitting into only three components takes place, since due to the lacking shear stress in the fluid vulcanization mixture 16, no transverse wave propagation takes place.

As a result, an intensity of the reflected longitudinal waves is measured as the measurement signal. This intensity depends distinctly on the state of the vulcanization mixture 16. In other words, the intensity of the reflected longitudinal waves depends on whether or how strongly the transverse waves can propagate in the vulcanization mixture 16. This in turn depends on how far the cross-linking has advanced during the vulcanization process. The degree of cross-linking and thus the progress of the vulcanization process can therefore be measured by means of a change in the intensity of the longitudinal waves, that is the twice reflected ultrasonic waves.

In order, for example, to be able to compensate for age-related changes in the ultrasonic transducer 24, a reference reflection element 40 is provided. The reference reflection element 40 is also referred to as a “reference reflector”. By means of the detection device, that is, by means of the ultrasonic transducer 24, a first part of the previously emitted ultrasonic waves twice reflected at the boundary surface 20 is detected. Furthermore, by means of the detection device, that is, by means of the ultrasonic transducer 24, a second part of the previously emitted ultrasonic waves different from the first part and reflected by means of the reference reflector is detected. The first part is illustrated, for example, by the double-headed arrow 28, whereas the second part is illustrated by a dashed double-headed arrow 42.

It is evident from FIG. 1 that the reference reflection element 40 is arranged in the tool part 18. The reference reflection element is introduced into the tool part 18, for example, in that firstly a bore is created. The reference reflection element 40 is arranged in this bore. Subsequently, the bore is closed.

The measurement signal is determined depending on the first part. Depending on the second part, a normalizing signal is determined which is designated the reference signal. The measurement signal is normalized by means of the normalizing signal (reference signal). For this purpose, for example, a quotient is formed, the numerator of which is the measurement signal and the denominator of which is the normalizing signal. In other words, in the context of the normalization of the measurement signal, it is related to the normalizing signal or placed in relation to the normalizing signal. Finally, the vulcanization process is monitored depending on the normalized measurement signal.

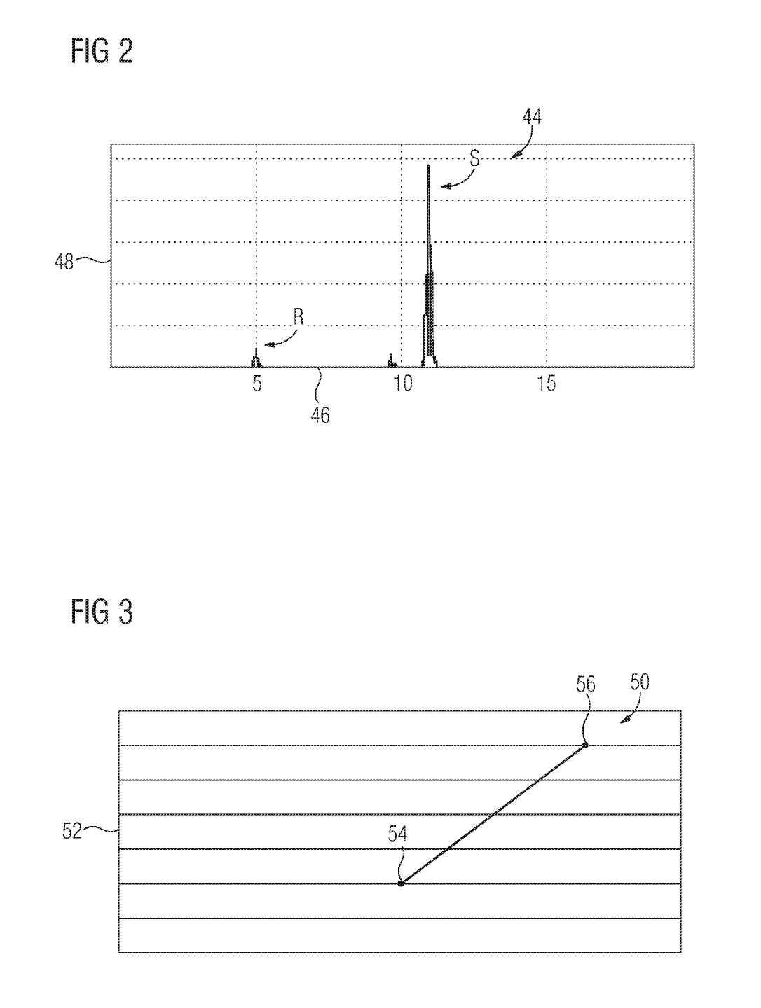

FIG. 2 shows a graphical representation 44 on the abscissa 46 of which is shown time and on the ordinate 48 of which, the respective amplitudes of the measurement signal identified in FIG. 2 as S and of the reference signal identified in FIG. 2 as R. It is apparent from FIG. 2 that in the context of the monitoring of the vulcanization process, an amplitude measurement of the reflected ultrasonic waves is carried out at two different run time windows. In other words, in order to determine the measurement signal S and the reference signal R, it is detected what time lies between the emission of the ultrasonic waves and the detection of the ultrasonic waves. The ultrasonic waves for determining the measurement signal S require a longer time since following the emission they are initially reflected at the boundary surface 20 in the direction of the reflection element 32, then reflected back by means of the reflection element 32 in the direction of the boundary surface 20, and are then reflected by means of the boundary surface 20 in the direction of the ultrasonic transducer 24 and finally are detected by means of the ultrasonic transducer 24.

The ultrasonic waves for determining the reference signal R, however, are reflected back following the emission merely by means of the reference reflection element 40 in the direction of the ultrasonic transducer 24 and are then detected by means of the ultrasonic transducer 24. This means that the ultrasonic waves for determining the reference signal R have a significantly shorter transit time than the ultrasonic waves for determining the measurement signal S.

FIG. 3 shows a graphical diagram 50 on the ordinate 52 of which the ratio of the measurement signal S to the reference signal R is plotted. A first measurement point 54 characterizes the ratio at a time point at which the vulcanization mixture 16 is still fluid. A second measurement point 54 characterizes the ratio at a time point at which the vulcanization mixture 16 is already cross-linked, that is, converted to solid or elastic rubber. From FIG. 3, it is particularly clear that the ratio and thus the measurement signal S in the elastic rubber is significantly larger than in the still fluid vulcanization mixture 16.

This means that the intensity of the detected and twice reflected longitudinal waves in solid rubber is significantly higher than in the still fluid vulcanization mixture 16. This means that the cross-linking of the vulcanization mixture 16 in the context of the vulcanization process is associated with a change in the intensity of the twice reflected longitudinal waves. This change in the intensity can be detected particularly clearly and precisely so that the time point of the vulcanization process at which the vulcanization process is sufficiently completed can be detected particularly precisely. Thus the time and the costs for producing the product can be kept low.

In other words, FIG. 3 shows the so-called A image which is detected by means of the detection device. The peak of the reference signal R is low and is detected significantly earlier than the peak of the measurement signal S. FIGS. 2 and 3 relate, for example, to a reflection angle (angle α) of 45 degrees. It is clear from FIG. 3 that in the selected configuration, a significant rise in the measurement signal S from the fluid phase to the solid rubber takes place. Through normalization with the reference signal R, therefore, a reliable detection can be ensured.

An optimization of the signal difference and thus of the signal change between fluid vulcanization mixture 16 and solid or elastic rubber can be achieved, for example, by optimizing the reflection angle. Alternatively or additionally, an optimization through the use of transverse waves for the irradiation can be achieved. Herein the proportion of the transverse component that is transmitted into the rubber is increased so that the signal change between the solid and the fluid state can be optimized. The realization of a particularly high proportion of the transverse component in the ultrasonic waves, can in principle be realized in two ways. Firstly, for example, the ultrasonic transducer 24 can be configured to emit transverse waves as the ultrasonic waves. This means, for example, that the ultrasonic waves generated and emitted by means of the emitting device 22 comprise at least transverse waves which are generated by means of the emitting device 22 temporally before the reflection of ultrasonic waves caused, in particular, for the first time by the boundary surface 20.

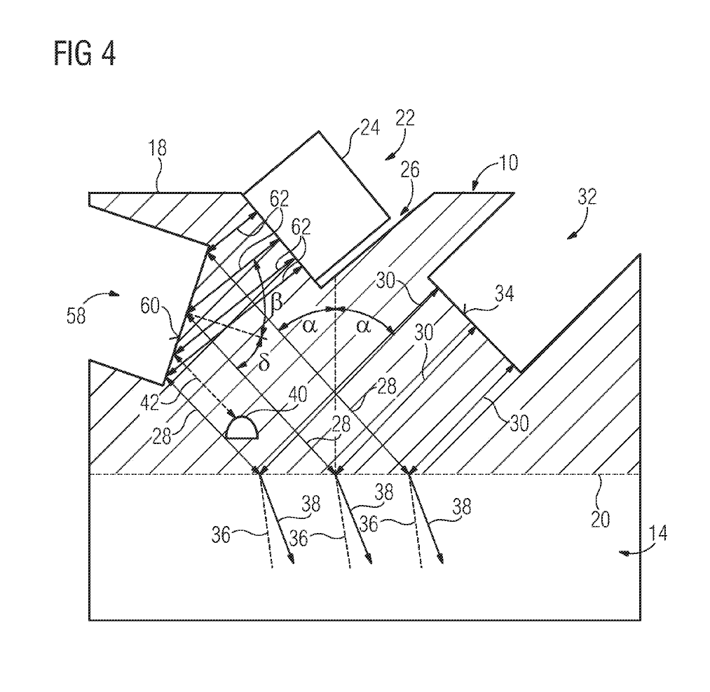

Secondly, in order to realize a particularly high proportion of the transverse component in the ultrasonic waves, the arrangement shown in FIG. 1 can be modified. A modification of this type is illustrated in FIG. 4. This means that FIG. 4 shows the hot press 10 according to a second embodiment. In the second embodiment, in addition to the reflection element 32, a further reflection element 58 different from the reflection element 32, from the reference reflection element 40 and from the boundary surface 20 is provided. The reflection element 58 also comprises a reflection surface 60 at which ultrasonic waves can be reflected. Like the reflection element 32, the reflection element 58 can be configured as a recess or receptacle of the tool part 18. The reflection surface 60 is formed, for example, by a flat and even floor of the recess. Herein, the reflection element 58 can be configured as a flat-bottom bore of the tool part 18.

In the second embodiment, the ultrasonic transducer 24 is configured for generating and emitting longitudinal waves. These longitudinal waves generated and emitted by means of the ultrasonic transducer 24 are illustrated in FIG. 4 by solid double-headed arrows 62. The longitudinal waves generated by the ultrasonic transducer 24 and emitted in the direction of the reflection element 58 are incident at an incidence angle β to the reflection surface 60 thereon and are reflected therefrom at an emission angle δ to the reflection surface 60 thereat and are emitted from the reflection surface 60 in the direction of the boundary surface 20. The incidence angle β and the emission angle δ are herein selected such that at least a part of the longitudinal waves generated by means of the ultrasonic transducer 24 and emitted in the direction of the reflection element 58 are transformed into transverse waves.

The respective recess of the reflection elements 32, 58 is filled, for example, with air. This means that a boundary surface between the reflection element 58 and the tool part 18 is delimited firstly by the air in the recess of the reflection element 58 and secondly by the steel of the tool part 18. In the case of this steel-air combination, the incidence angle β is may be at least substantially degrees, wherein the emission angle δ may be at least substantially 29 degrees.

It is apparent, overall, that the ultrasonic waves for determining the measurement signal S comprise at least transverse waves which are generated by means of the emitting device 22 temporally before the reflection of the ultrasonic waves caused for the first time by the boundary surface 20. By this means, the proportion of the transverse component in the ultrasonic waves for determining the measurement signal S can be configured particularly high so that the transition of the vulcanization mixture 16 from the fluid state to the solid state can be detected particularly well.

Herein, for monitoring of the vulcanization process, the different propagation behavior of longitudinal and transverse waves is utilized. It is thus possible to detect the conversion process from the fluid phase into the solid or cross-linked rubber phase online merely by means of a reflection measurement. This enables a simple installation of the method into external hot press molds without the use of a transmission measurement.

A smooth site of the product to be produced, for example at a side wall of the tire may be selected in order to bring about the double reflection of the ultrasonic waves there. At a smooth site of this type, a disruptive influence of the tire profile on the boundary surface 20 can be prevented. If this online measurement is integrated into a process control system, for example, the vulcanization of the product can take place in a state-oriented manner so that a time and energy-optimization and a productivity increase can be achieved. Furthermore, by this means, valuable information can be gained in the development of new rubber mixtures and manufacturing recipes.

Further, using the second embodiment illustrated in FIG. 4, the reference reflection element 40 is provided, by means of which the measurement signal is normalized. The function of the reference reflection element 40 outlined by reference to FIG. 1 and the first embodiment can also be transferred without difficulty to FIG. 4 and the second embodiment.

What is claimed is:

1. A method for monitoring a vulcanization process of a vulcanization mixture accommodated in a tool, the method comprising:
using an emitting device, to emit ultrasonic waves toward a boundary surface between the vulcanization mixture and the tool,
the boundary surface reflecting at least a part of the ultrasonic waves,
monitoring the vulcanization process based on at least a part of the emitted ultrasonic waves reflected at the boundary surface,
wherein the ultrasonic waves comprise at least transverse waves generated by the emitting device.

2. The method of claim 1, wherein the transverse waves are generated by the emitting device before the reflection of the ultrasonic waves by the boundary surface.

3. The method of claim 1, comprising emitting the transverse waves by at least one ultrasonic emitter of the emitting device.

4. The method of claim 1, comprising emitting longitudinal waves by at least one ultrasonic emitter of the emitting device toward at least one reflection element of the emitting device,
wherein the reflection element transforms at least a part of the longitudinal waves into the transverse waves.

5. The method of claim 1, comprising using at least one further reflection element to reflect at least a part of the ultrasonic waves reflected by the boundary surface back to the boundary surface.

6. The method of claim 5, comprising receiving, by at least one receiving element, at least a part of the ultrasonic waves that are reflected at the boundary surface, reflected back to the boundary surface by the at least one further reflection element, and reflected again at the boundary surface.

7. The method of claim 3, wherein the at least one ultrasonic emitter is configured as an ultrasonic transducer, and the method comprises detecting the reflected ultrasonic waves by the ultrasonic transducer.

8. The method of claim 1, comprising:
receiving, by at least one receiving element of the emitting device, longitudinal waves received from the boundary surface, and
monitoring the vulcanization process based on the detected longitudinal waves.

9. The method of claim 1, comprising:
detecting (a) a first part of the ultrasonic waves reflected at the boundary surface and (b) a second part of the ultrasonic waves different from the first part of the ultrasonic waves and reflected by a reference reflection element;
determining a measurement signal based on the detected first part of the ultrasonic waves;
determining a normalizing signal based on the detected second part of the ultrasonic waves;
normalizing the measurement signal based on the normalizing signal; and
monitoring the vulcanization process based on the normalized measurement signal.

10. A device for monitoring a vulcanization process of a vulcanization mixture accommodated in a tool, the device comprising:
an emitting device configured to emit ultrasonic waves toward a boundary surface between the vulcanization mixture and the tool, the boundary surface reflecting at least a part of the ultrasonic waves;
a detection device configured to detect at least a part of the emitted ultrasonic waves reflected at the boundary surface; and
an evaluation device configured to monitor the vulcanization process based on the detected ultrasonic waves detected;
wherein the emitting device is configured to generate at least transverse waves as the ultrasonic waves.

11. (canceled)

12. A device for monitoring a vulcanization process of a vulcanization mixture accommodated in a tool, the device comprising:
an emitting device configured to emit ultrasonic waves toward a boundary surface between the vulcanization mixture and the tool, the boundary surface reflecting at least a part of the ultrasonic waves;
a detection device configured to detect (a) a first part of the ultrasonic waves reflected at the boundary surface and (b) a second part of the ultrasonic waves different from the first part of the ultrasonic waves and reflected by at least one reference reflection element; and
an evaluation device configured to:
determine a measurement signal based on the detected first part,
determine a normalizing signal based on the detected second part;
normalize the measurement signal based on the normalizing signal; and
monitor the vulcanization process based on the normalized measurement signal.
